(19) United States
(12) Patent Application Publication
(10) Pub. No.: US 2002/0188936 A1
(43) Pub. Date: Dec. 12, 2002

(54) Synchronous script object access

(76) Inventors: Peter Bojanic, Ottawa (CA); Shervin Shirmohammadi, Ottawa (CA); Dan Parent, Ottawa (CA)

Correspondence Address: Shapiro Cohen, Station D, P.O. Box 3440, Ottawa, ON, K1P 6P1, CA

(21) Appl. No.: 09/877,204

(22) Filed: Jun. 11, 2001

(51) Int. Cl. G06F 9/445

(52) U.S. Cl. 717/171; 717/168

(57) ABSTRACT

Methods and products for providing content to a user window on a client computer without the need for reloading or refreshing a whole web page. The content is sent to a synchronous window invisible to the user on the client computer in a format acceptable to the sync window. A user application can then retrieve the content from the sync window and present it to the user without the need to load the entire page. The transfer of content can be made even more efficient by sending the content in the form of browser script and without the need for vendor, program or application specific formats or converters.

### FIELD OF THE INVENTION

The present invention relates to Internet browsers. More specifically, it relates to products and methods which allow content to be refreshed and displayed without the need for reloading a target page.

### BACKGROUND TO THE INVENTION

The growth of the Internet in the past few years has not only given rise to more Internet users but also to more sophisticated web pages and Internet browsers. This has also given rise to a growing demand by users for increasingly complex web pages. Unfortunately, the present method of delivery web content to users is still static—a user is presented with a monolithic web page which is created and presented by the content provider. To change the content, the whole page has to be recreated statically or dynamically by the content provider or it can be recreated automatically by the user by reloading.

This is clearly not only inefficient, but can be quite annoying for the user. Long wait times, as the user waits for the content provider to recreate the page and for the reloading of the page, are not unknown to long suffering users. This approach also prevents users from accessing the pages as the recreated page is being recreated.

A way around this problem has been for the user to open multiple instances of his web browser and to continuously refresh the browser copy which has the page being refreshed. However, this approach does not avoid the problem—long wait times for the page to be recreated and reloaded. Furthermore, it does not address all situations. Another major drawback of this approach is the heavy burden on user system resources that multiple browser instances necessitate.

Based on the above, there is a need for methods and products which will allow web users quick access to desired data without the need for lengthy recreation and reloading of full web pages.

### SUMMARY OF THE INVENTION

The present invention provides method and products for providing content to a user window on a client computer without the need for reloading or refreshing a whole web page. The content is sent to a synchronous window invisible to the user on the client computer in a format acceptable to the sync window. A user application can then retrieve the content from the sync window and present it to the user without the need to load the entire page. The transfer of content can be made even more efficient by sending the content in the form of browser script and without the need for vendor, program or application specific formats or converters. For clarification it should be noted that the term window refers to at least a portion of a display.

In a first aspect, the present invention provides a method of providing content to a user window in a client computer from a server computer, the method comprising initiating a request for content from the client machine, creating a sync window at the client machine, said sync window being invisible to a user, sending a sync request from said sync window to a loader module running on said server computer receiving said sync request at said loader module, retrieving relevant requested data parameters from said sync request by said loader module, retrieving requested data by a data manager module at said server computer, converting requested data into a format acceptable to said sync window based on parameters retrieved transmitting converted requested data to said sync window at said client computer receiving converted requested data at said sync window and retrieving converted requested data from said sync window for presentation at said user window.

In a second aspect, the present invention provides a software product for use with a client computer resident web browser for displaying content in a user window in said web browser, said product including an end user module for initiating a request for content for said user window, a sync window controller module for creating at least one sync window and for controlling said at least one sync window, wherein when said end user module initiates a request for content, said sync window controller module creates a sync window invisible to a user, said sync window controller module formulates and transmits to a server a sync request for content, said sync window receives content from said server, said end user module retrieves content from said sync window and displays said content on said user window.

In a third aspect, the present invention provides a software product for use with a server computing device for servicing requests for content from a client computing device, said software product including a loader module for receiving requests for content and for managing said requests for content, a data manager module for retrieving requested data based on said requests for content and a data delivery module for delivering content to said client, wherein said loader module receives requests for content from said client, said loader module extracts from said requests relevant requested data parameters, said loader module determines content requested by said client and instructs said data manager to retrieve data based on said content requested, said data manager module retrieves data based on relevant requested data parameters extracted by said loader module and said data retrieved by said data manager module is delivered to said client by said data delivery module.

### BRIEF DESCRIPTION OF THE DRAWINGS

A better understanding of the invention may be obtained by reading the detailed description of the invention below, in conjunction with the following drawings, in which:

FIG. 1 is a block diagram of a client/server system according to the invention and illustrates the software modules required to practice an embodiment of the invention; and

FIG. 2 is a flow chart detailing the steps of a process according to another embodiment of the invention.

### DETAILED DESCRIPTION

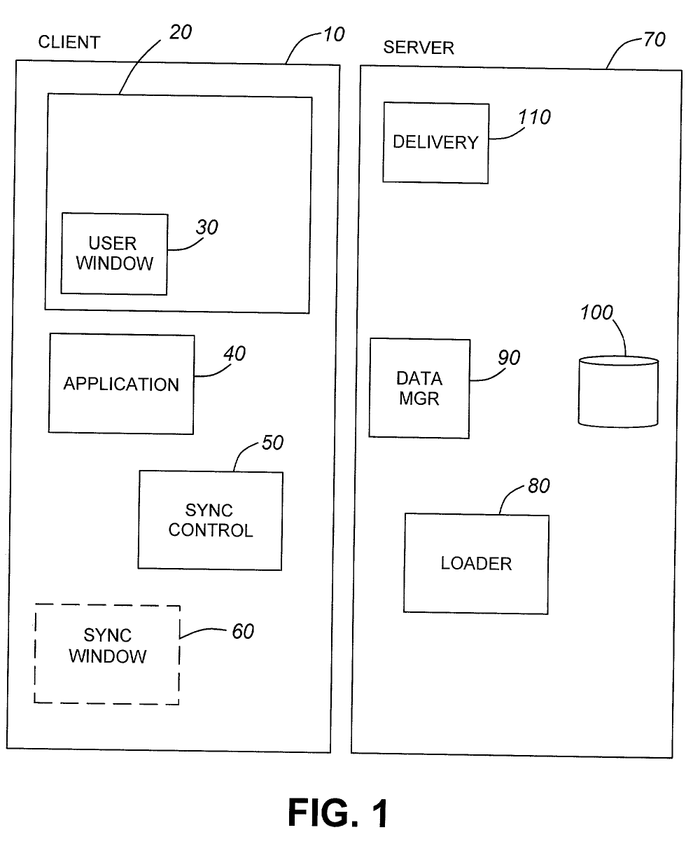

Referring to FIG. 1, a block diagram of a client/server system with the software modules required for an embodiment of the invention is illustrated. A client computer 10 has a web browser program 20. Within the web browser 20 is a user window 30 visible to the user. To add content to the user window 30, an application 40 initiates a request for content for the user window 30. This request for content may be user initiated with the user listing a specific site from which content is to be retrieved (such as a news service) or may be automatic, such as a service bulletin from an ISP (Internet Service Provider) alerting the user of important changes. This request can take the form of a specific command which retrieves content or of a database query that retrieves the content from the content provider's database. When the application initiates the request, a synchronization controller module (or sync controller module) 50 receives the request. The sync controller module 50 then creates a synchronization window (sync window) 60 which will be used as the repository for content received from a server computer 70. The sync controller 50 then formulates and transmits a synchronization request for data/content to the server 70.

The server computer 70 has within it a number of software modules which will service the request initiated by the application 40. The server computer 70 has a loader module 80, a data manager module 90, a database 100, and a delivery module 110.

The loader module 80 receives the sync request from the sync controller 50 of the client computer 10. The loader module 80 then decodes the sync request to determine the parameters of the request including what content is being requested.

Once the request has been decoded, the data manager module 90 receives the relevant requested data parameters retrieved from the sync request. The data manager module 90 then retrieves the data requested from either the interval database 100 or from an outside source such as another website. After the data has been retrieved, it is then packaged so that it will be acceptable to the sync window 60. This can be done either by the data manager module 90 or the delivery module 110. As the name implies, the delivery module 110 transmits the retrieved data, now packaged properly as content, to the synch window 60 in the client computer 10.

The client computer 10 receives the content through the sync window 60. Once the synch window 60 receives the content, the application 40 is informed that the content is ready for use. The content is kept in the sync window 60 until the application 40 required it. Once the application 40 needs content to be sent to the user window 30, the content is retrieved from the sync window 30 and presented in the user window 30.

When the application 40 no longer needs a user window 30, the user window may be closed or, if the application 40 requires a different type of content from that kept in the sync window 60, the sync window 60 may be terminated by the sync controller module 50. The sync controller module 80 may then create a new sync window for different content.

It should be noted that multiple sync windows may exist at the same time, with each sync window being shared to a specific user window and a specific content type for that user window. Each sync window would be controlled by the sync controller module and each sync window would have its own unique address. Thus, content sent from the server would not only be addressed to the specific client computer requesting the content but also to the specific sync window dedicated to that specific content.

It should also be noted that the application 40, after retrieving the content from the sync window, can issue another request for content that need not cause another sync window to be produced. Instead, if the content parameters (such as the type of content and where the content is to be retrieved from) remain the same, then the sync controller module merely issues the same sync request to the server computer. This has the effect of refreshing the content already resident in the sync window. Any changes to the content is then reflected in the sync window and can be retrieved by the application accordingly.

It should be clear from the above that the sync controller module 50 in the client computer and the loader module 80 in the server computer 70 need to work together to synchronize the requested content and its parameters. The sync request from the sync controller module 50 to the loader module 80 not only details what type of content is requested (such as text, video or audio), but also where it is to be found (source website), and the acceptable format the delivered content should be in. Furthermore, as there might be multiple client computers with multiple sync windows, the specific logical address of not only the requesting client computer but also of the specific sync window must be specified. The requesting client computer may be identified using a logical address while the sync window may be identified by a specific label or address in that client computer.

The sync request may, if desired, also document the required data rate at which the content is to be delivered. This would help avoid network congestion if a high bandwidth connection is desired but is not available.

For maximum compatibility, using a browser script format for the content is advisable. This is because browser script is widely recognized and can be dealt with by practically all Internet browser applications.

It should be also noted that any programming language can be used to implement the invention. Javascript can also be used as the script sent between the client and the server.

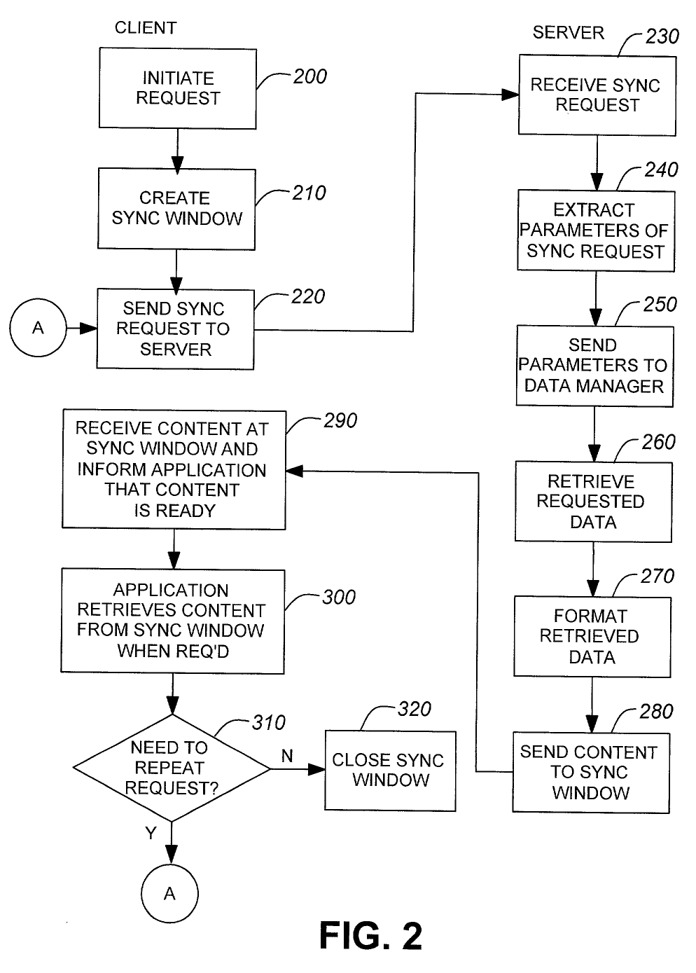

Referring to FIG. 2, a flowchart of the process outlined above is illustrated. As can be seen, the process begins with the user application initiating a request for content in step 200. Once the request has been initiated, a sync window is created in step 210. With the sync window created, sync request is then sent from the sync controller module to the server computer in step 220. This sync request is received by the server computer in step 230.

Once the request is received, the loader module in the server computer then extracts the relevant information from the request in step 240. These parameters are then sent to the data manager module in step 250. These parameters are used in step 260 to retrieve the requested data, either from an internal database or from an external website. Step 270 is then that of formatting the retrieved data into an acceptable format. Since unneeded components will not be retrieved by step 260, formatting may not involve removing unwanted components. Formatting also involves converting the required data into a format that the sync window can accept. As noted above, this format is ideally that of browser script.

Once the data is formatted, it is then sent to the client computer (step 280). This content is the received by the sync window in the client computer (step 290). At this point, the sync window informs the application that the data is ready for use. The content is held in the sync window until the application requires an update or when the application needs to display or interact with the content in the user window. When this event occurs, the application retrieves the content from the sync window (step 300).

After the content has been retrieved from the sync window and presented via the user window, a decision 310 has to be made. If the content requires a refresh, then the content request has to be repeated. To do this, the process is restarted from step 220, as can be seen from the flowchart through connector A. If, on the other hand, the content is not to be refreshed, then the sync window is terminated (step 320).

It should be noted that steps 200-220 and 290-320 are executed in the client computing device while steps 230-280 are executed in the server computing device.

It should be noted that while FIG. 1 illustrates the client and the server as being separate entities, these two can reside in the same device or node. Thus, a single computer can have a module which performs the functions of a client and a module which performs the functions of a server. Furthermore, client and the server need not be computers. The term “computers” in this document should be construed to include all manner of computing devices such as PDA (personal digital assistants), hand held computers, Internet appliances, or any other device which processes data and can run an Internet browser program.

A person understanding the above-described invention may now conceive of alternative designs, using the principles described herein. All such designs which fall within the scope of the claims appended hereto are considered to be part of the present invention.

We claim:

1. A method of providing content to a user window in a client computer from a server computer, the method comprising:
a) initiating a request for content from the client computer;
b) creating a sync window at the client computer, said sync window being invisible to a user;
c) sending a sync request from said sync window to a loader module running on said server computer;
d) receiving said sync request at said loader module;
e) retrieving relevant requested data parameters from said sync request by said loader module;
f) retrieving requested data by a data manager module at said server computer;
g) converting requested data into a format acceptable to said sync window based on parameters retrieved in step e);
h) transmitting converted requested data to said sync window at said client computer;
i) receiving converted requested data at said sync window; and
j) retrieving converted requested data from said sync window for presentation at said user window.

2. A method as in claim 1 wherein relevant requested data parameters include at least one parameter chosen from a group comprising:
acceptable data formats for said sync window;
logical address of said client computer;
identifying label for said sync window;
address from which requested data is to be retrieved; and
data rate at which retrieved data is to be sent to said sync window.

3. A method as in claim 1 further including the step of closing the sync window when said request for content has been satisfied.

4. A method as in claim 1 further including periodically reinitiating said request for content to refresh said content.

5. A method as in claim 1 wherein said format acceptable to said sync window is browser script format.

6. A method as in claim 1 wherein said content is text based.

7. A method as in claim 1 wherein said content is based on a format chosen from the following:
video based;
audio based; and
rich media.

8. A software product for use with a client computer resident web browser for displaying content in a user window in said web bowser, said product including:
an end user module for initiating a request for content for said user window;
a sync window controller module for creating at least one sync window and for controlling said at least one sync window;
wherein when said end user module initiates a request for content, said sync window controller module creates a sync window invisible to a user,
said sync window controller module formulates and transmits to a server a sync request for content;
said sync window receives content from said server;
said end user module retrieves content form said sync window and displays or interacts with said content on said user window.

9. A software product for use with a server computing device for servicing requests for content from a client computing device, said software product including:
a loader module for receiving requests for content and for managing said requests for content;
a data manager module for retrieving requested data based on said requests for content; and
a data delivery module for delivery content to said client,
wherein
said loader module receives requests for content from said client;
said loader module extracts from said requests relevant requested data parameters;
said loader module determines content requested by said client and instructs said data manager to retrieve data based on said content requested;
said data manager module retrieves data based on relevant requested data parameters extracted by said loader module; and
said data retrieved by said data manager module is delivered to said client by said data delivery module.

10. A software product as in claim 9 wherein said data retrieved by said data manager module is formatted into a format determined by said relevant requested data parameters.
